(19) United States
(12) Patent Application Publication
(10) Pub. No.: US 2009/0006151 A1
(43) Pub. Date: Jan. 1, 2009

(54) COLLECTION OF RECEIPT DATA FROM POINT-OF-SALE DEVICES

(76) Inventors: Jay Zarghami, Honolulu, HI (US); Michael Melcher, Honolulu, HI (US); Bryan Wilcutt, Honolulu, HI (US)

Correspondence Address: Leighton K. Chong;Patent Attorney, 133 Kaai Street, Honolulu, HI, 96821, US

(21) Appl. No.: 11/772,083

(22) Filed: Jun. 29, 2007

(51) Int. Cl. G06Q 10/00

(52) U.S. Cl. 705/7; 235/462.01

(57) ABSTRACT

A customer receipt data collection robotic (RBOT) device is connected to a point-of-sale (POS) device, such as a cash register, through an available connection link, such as an available auxiliary printer port or in-line connection. The RBOT device operates autonomously to collect receipt data for transmission to a Data Center for storing and processing the collected receipt data and making the results thereof accessible online to vendors and customers. The customer receipt data are tagged with the customer's ID number by scanning a customer barcode ID or a magstripe customer ID store card. At the Data Center, useful data mining functions are performed on the collected receipt data, and the results are made available online to vendors for inventory control and/or product sales purposes, and to customers for accessing their purchase histories and/or for customer loyalty, discount and/or reward programs.

### TECHNICAL FIELD

This U.S. patent application is directed to data collection from point-of-sale (POS) devices, and particularly, to the collection of customer purchase or receipt data from POS cash registers for use in vendor inventory control and customer loyalty, discount and/or reward programs.

### BACKGROUND OF INVENTION

Retail stores have point-of-sale (POS) devices such as cash registers connected to printers and user input terminals for entering customer purchase data, printing paper receipts, and validating credit card and other payment methods used by customers. Many vendor POS terminals also allow the customer to swipe a customer loyalty card or input a customer ID number to identify customer purchase information for customer loyalty, discount and/or reward programs.

Various systems have been proposed for collecting customer purchase data for various data analysis functions. For example, U.S. Pat. No. 6,886,742 discloses a POS system for customer loyalty programs which sends POS data to an aggregator which acts as an intermediary between an issuer association and a plurality of merchants. The aggregator performs data mining for point histories, coupon and reward programs.

WO Publication 01/080141 discloses extracting POS data at a multi-device communications port (TAP) used to route dial-up calls for bank authorization of credit card charges, and sending the extracted data via Internet to a website for analysis.

WO Publication 01/004818 discloses data capture from POS terminals using a POS server PC (MIGATA 16), and sending the extracted data via Internet to a website for analysis.

U.S. Published Application 2006/0059040 discloses a POS system for data transfer in a distributed network for managing customer loyalty data on an Internet website.

U.S. Pat. No. 5,774,872 discloses a POS system for transaction reporting and data collection which includes reporting tax data to a government data location.

U.S. Published Application 2003/0074254 discloses a POS data collection system which records the transaction number of receipts issued to customers, and then acquires the POS data matching the transaction numbers in a database for sales management, inventory management, procurement management, or the like.

However, the prior systems for gathering customer purchase data for useful data analysis have the shortcoming of being configured as integrated systems that must be obtained from original equipment manufacturers (OEM) employing proprietary operating systems and proprietary data formatting and data conversion protocols. Consequently, customer purchase data cannot be readily collected from different vendors or retail chain stores and made available to customers who may shop at many different stores. It would be desirable to implement a customer purchase data collection system that can be deployed with a wide range of different vendors and chain stores using different types of POS systems and that can perform various desirable data analysis functions and make the results thereof readily available to store vendors and customers.

### SUMMARY OF INVENTION

In accordance with the present invention, a customer receipt data collection robotic (RBOT) device is connected to a point-of-sale (POS) device, such as a cash register, through an available connection link, such as an available auxiliary printer port or in-line connection. The RBOT device operates autonomously to collect receipt data for transmission to a Data Center for storing and processing the collected receipt data and making the results thereof accessible online to vendors and customers. The Data Center is a repository system containing the necessary hardware, database, and software for storing the received receipt data and performing various data analysis functions to provide useful analysis results to vendors and customers.

In a preferred implementation of the invention, the customer receipt data is generated by a POS device and sent via an output port to a receipt printer. The RBOT device collects the same receipt data through an available auxiliary output port of the POS device. If no auxiliary data output port is available, the RBOT device can be connected as an in-line module between the POS device output port and the receipt printer. The RBOT device autonomously collects the receipt data from the POS device and transmits the data to the Data Center through a connecting link. In the typical retail store environment, for example, the RBOT device can upload the data wirelessly via a Wi-Fi hub installed in the store via Internet to the Data Center. The customer receipt data are tagged with the customer's ID number by scanning a customer barcode ID with an on-board scanner of peripheral to the RBOT device, or alternatively having the customer swipe their customer ID store card in an input terminal during the checkout transaction. At the Data Center, useful data mining functions are performed on the collected receipt data. The data mining results can then be made available online via a website connected to the Data Center to vendors for inventory control and/or product sales purposes, and to customers for accessing their purchase histories and/or for customer loyalty, discount and/or reward programs.

Other objects, features, and advantages of the present invention will be explained in the following detailed description of the invention with reference to the appended drawings.

### BRIEF DESCRIPTION OF DRAWINGS

FIG. 1 illustrates the architecture of the overall receipt data collection system including POS device, RBOT device, Internet connection, Data Center, and users.

FIG. 2 lists the main elements constituting the RBOT device.

FIG. 3 lists the main functions of the network-based Data Center receiving the collected receipt data from POS devices.

FIGS. 4A and 4B list some of the main advantages that users can obtain by interfacing with the online website for the system.

FIG. 5 shows a typical transmission negotiated between a Data Center server and the RBOT device.

FIG. 6 shows an example of the time out sequence with recovery ladder for transmission error correction between the RBOT device and the Data Center server.

FIG. 7 shows a ladder diagram of a Flash Load exchange between the Data Center's server and the RBOT device.

FIG. 8 shows a diagram of a code load protocol exchange for error monitoring between the Data Center's server and the RBOT device.

### DETAILED DESCRIPTION OF INVENTION

In the following detailed description of the invention, certain preferred embodiments are illustrated providing certain specific details of their implementation. However, it will be recognized by one skilled in the art that many other variations and modifications may be made given the disclosed principles of the invention.

### System Overview

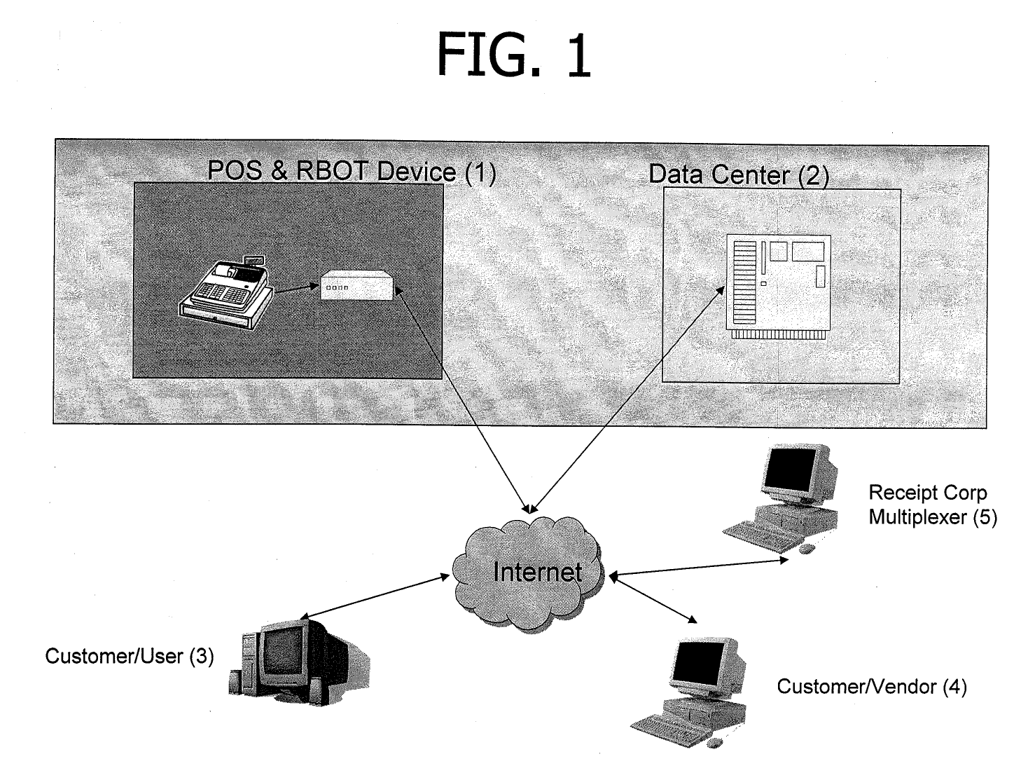

Referring to FIG. 1, the receipt data collection system employs a receipt data collection robotic (RBOT) device (1) that is connected to a point-of-sale (POS) device, such as a cash register, through an available connection link. The connection link can be an available auxiliary output port of the cash register or, if none is available, the RBOT device can be connected as an in-line module between the cash register printer port and the receipt printer. The RBOT device operates autonomously to collect the receipt data from the POS device and transmit the data to a data center for the system, labeled in the drawing as Data Center (2). RBOT devices can be deployed with respective POS devices in a store's POS domain, and with many other store POS domains to serve as a many-to-one connection between the store POS domains and the Data Center (2). The Data Center (2) in turn provides online services to desired users such as a store's Customer/User (3), a Customer/Vendor (4), and the system operator (referred to herein as “Receipt Corp”), labeled in the drawing as Multiplexer (5).

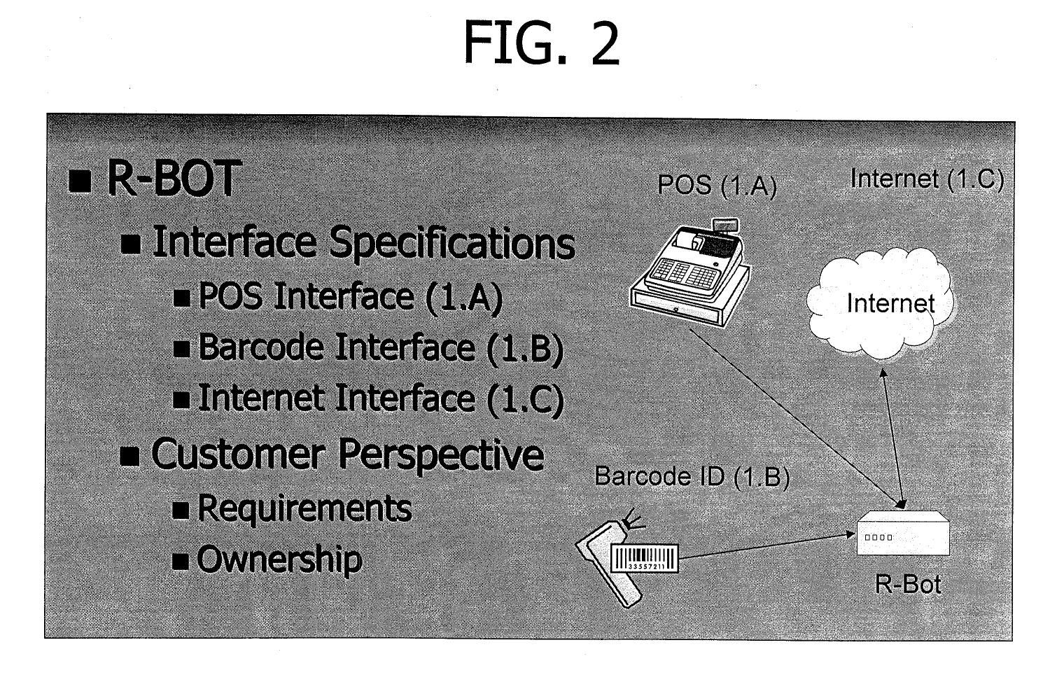

Referring to FIG. 2, the RBOT device is configured with interfaces to the store domain's POS device (POS interface 1.A), a customer ID input device such as a barcode reader (Barcode ID interface 1.B) or a card swipe terminal, and to the Data Center preferably via the Internet (Internet interface 1.C). As described in further detail below, the RBOT device is configured to implement various data collection policies consistent with the Customer Perspective, such as personal and financial privacy, and Ownership Policies for the data.

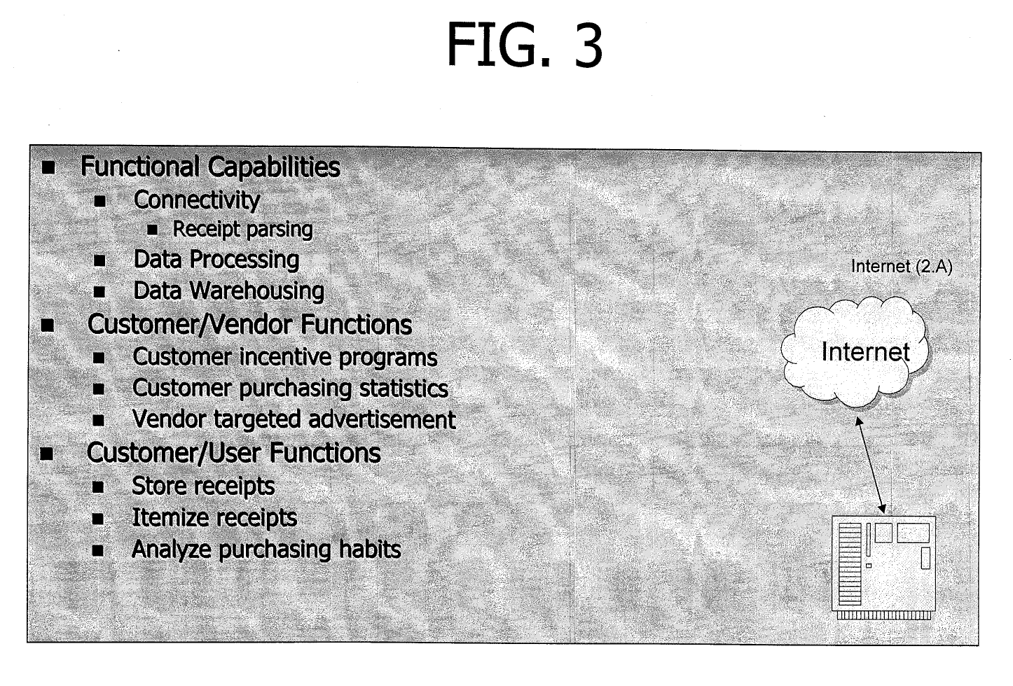

Referring to FIG. 3, the Data Center (2) is a repository system containing the necessary hardware, database, and software to collect and store the received customer receipt data, and to perform desired data analysis functions on the data and make the results thereof accessible to vendors and customers online. Besides the functional capabilities of connectivity and receipt data parsing, the Data Center provides data warehousing and processing functions for any Customer/Vendor (4), data warehousing and processing functions for any Customer/User (3), as well as monitoring and control functions for the system operator (Receipt Corp).

The domain of the Customer/Vendor (4) can consist of an Internet-connected computer using a standard Internet browser. Customer/Vendor (4) data warehousing and processing functions can include customer incentive programs, customer purchasing statistics, and vendor targeted advertisement. The Customer/Vendor (4) interface is a many-to-one connection to the Data Center (2). There is no logical connection to the Customer/User (3) or the RBOT devices (1). The Customer/Vendor (4) domain provides added functionality not available to the Customer/User (3) domain. This functionality is described in further detail below.

The domain of a Customer/User (3) is similarly configured as the Customer/User (3) domain. The Customer/User (3) interface allows store customers, as end-users, to access and manage their receipt data collected from stores with POS devices connected to the Data Center (2). Customer/User (3) data warehousing and processing functions can include storing customer receipts, itemizing categories of purchases logged in customer receipts, and analyzing customer purchasing habits. The logical connection is between the Customer/User (3) and the online website for the Data Center (2). There is no access between the Customer/User and the POS domain provided by the system.

The system operator Multiplexer (5) can enable vendors to connect numerous on-site RBOT devices, by networking each device for connection to the system via wired or wireless Internet. This obviates the need to use connecting phone lines to obtain the RBOT-collected data from each POS device. The data collected by each RBOT device is processed into a batch file, and periodically transmitted to the Data Center (2) for further data warehousing and processing.

### POS & RBOT Domain

The RBOT device operates as an autonomous device that functions independently of the POS device or any proprietary operating systems or protocols supplied by OEMs for the POS device. The RBOT device is connected to the POS device, such as a cash register, via an available auxiliary (serial or parallel) port in order to capture receipt output information, correlate that information with a customer ID number (such as input by scanning a barcode ID or swiping a magstripe ID card). The RBOT device does not communicate information back to the POS device in any manner. The data format of the receipt information is not important for the RBOT's functioning. The RBOT transmits the receipt data as a batch file tagged with the customer ID number to the Data Center (2).

The Data Center is responsible for parsing the receipt data received from the RBOT transmission. Receipt data typically generated by POS devices has a header that identifies the store name or ID number. Alternatively, the RBOT device can be programmed to automatically insert a store ID header corresponding to the store POS domain it is installed in. By identifying the store or chain that is the source of a batch file of receipt data, the Data Center can load and apply the receipt data formatting methodology associated with that store or chain from a previously stored catalog of store receipt data formats. By parsing the receipt data batch file according to the corresponding store receipt data format, the Data Center can identify the respective data fields or sections within the batch file and index them in the database according to data field names. The parsed data for each customer purchasing transaction is also indexed by store ID number and customer ID number.

The RBOT device tags the customer receipt data with the customer's ID number input for a current transaction. For example, by utilizing a barcode reading system, the RBOT can mark the current output receipt data from the POS device with the customer's ID when it sends this information to the Data Center (2). Barcode-read customer-supplied IDs are a logical, efficient method of identifying receipt data by customer and may be cross referenced with other vendor-supplied barcodes. For example, associating a chain store supplied code, which may be automatically input by the POS device or read as input barcode by the RBOT device, with a customer ID provided by the overall system operator would eliminate the need for the customer to carry a number of store ID tags for the different stores the customer may shop at. The system operator can make customer loyalty programs easier to implement for the respective stores and become a common practice.

The barcode reader may be a built-in scanner with the RBOT device or an external scanner. The format of the barcode information may be either Type 1-D or Type 2-D barcode. Most common vendors use Type 1-D barcodes. The barcode ID is associated, either directly or indirectly, with the customer's unique ID. Multiple barcodes may be associated with a single customer ID.

The RBOT device may use any suitable algorithms to detect when to collect and tag the corresponding customer's receipt information. For example, it can detect when a barcode-read event has occurred after a customer presents a vendor-supplied or system-operator-supplied ID card to be scanned by the RBOT. Receipt data that start to stream or are recently streaming are consequently tagged by the RBOT as belonging to the customer identified by the recently-read barcode ID. This customer ID information is transmitted with the receipt data to the Data Center (2). When the receipt data streaming ends, the receipt data flag is cleared for next use of the RBOT device.

Alternatively, the customer may present a barcode ID before receipt data has started to be output from the POS device. If the RBOT does not detect receipt data streaming, it stores the customer ID data and initiates a timed period which allows a specific (TBD) time for receipt data to be received before resetting the RBOT state. The timed period may also expire if a different barcode ID is presented before the timed period expires. When the RBOT starts to receive receipt data within the timed period, the customer barcode ID is tagged to the receipt data and transmitted to the Data Center (2). The receipt data flag is then cleared for next use of the RBOT device.

The RBOT device can be provided with a given capacity of on-board memory storage for collecting multiple sets of receipt data before uploading via the Internet in bursts periodically to the Data Center. For a wired Internet connection, the RBOT may connect to the Internet via an Ethernet access block. RBOTs connected using this interface can also transmit receipt data immediately instead of buffering the data for periodic connects. Alternatively, the RBOT may connect using wireless Internet access, and receipt data can be transmitted immediately instead of buffered for periodic connection. Phone line connections to the Data Center may also be used if they are already supplied to the POS devices to do credit card clearances, for example. The RBOT may share a phone line with the POS device via a phone line splitter. The RBOT device can detect whether the phone line is currently in use via an off-hook mechanism before attempting to utilize the line. This allows the RBOT to share a phone line with other POS equipment, i.e., the POS credit card reader.

An Internet connection to the RBOT would enable it to perform a number of other functions, as exemplified but not limited to the following. The RBOT can transmit stored correlated receipt-to-customer ID data to the Data Center (2). Information successfully transmitted, via TCP/IP and private FTP connection, can be erased from the RBOT's memory. The format of the transmitted data shall be compressed to reduce bandwidth. The RBOT can also store or log internal statistical information on transactions that can be used for analysis by the system operator. This information, for example, can allow monitoring of the POS transactions and the RBOT's performance. The system operator can also upload new or updated software programs to the RBOT device whenever it is deemed necessary. This allows continual updating of the device's performance and built-in functionality. The RBOT can be configured to store the latest software program as well as a previous or default program, so that it can fall back on “last known working software” should there be a failure detected by the software or the RBOT hardware.

### Data Center Domain

This domain interfaces the Data Center by online access to the Customer/User and Customer/Vendor as users of the system. With a robust database system, such as Oracle, as well as massive storage systems, such as Filenet, the Data Center can archive large volumes of receipt information, process data mining operations, and provide accounting/billing information to large universes of store vendors and customers. For Customer/Vendors, the Data Center can implement any suitable data mining functions requested by vendor related to the inventory management, product sales analysis, customer incentive programs, customer purchasing statistics, and/or vendor targeted advertisement. The system may further provide Customer/Vendors with personalized vendor account management functions, such as:
1. Tracking grouped or targeted customer purchases
2. Tracking customer multiple or volume purchases for coupons, etc.
3. Tracking customer benchmark spending for coupons, etc.
4. Maintenance of customer tracking database system
5. Data mine purchasing trends for products and/or manufacturers locally, regionally or nationally, or for price sensitivities and market demand.

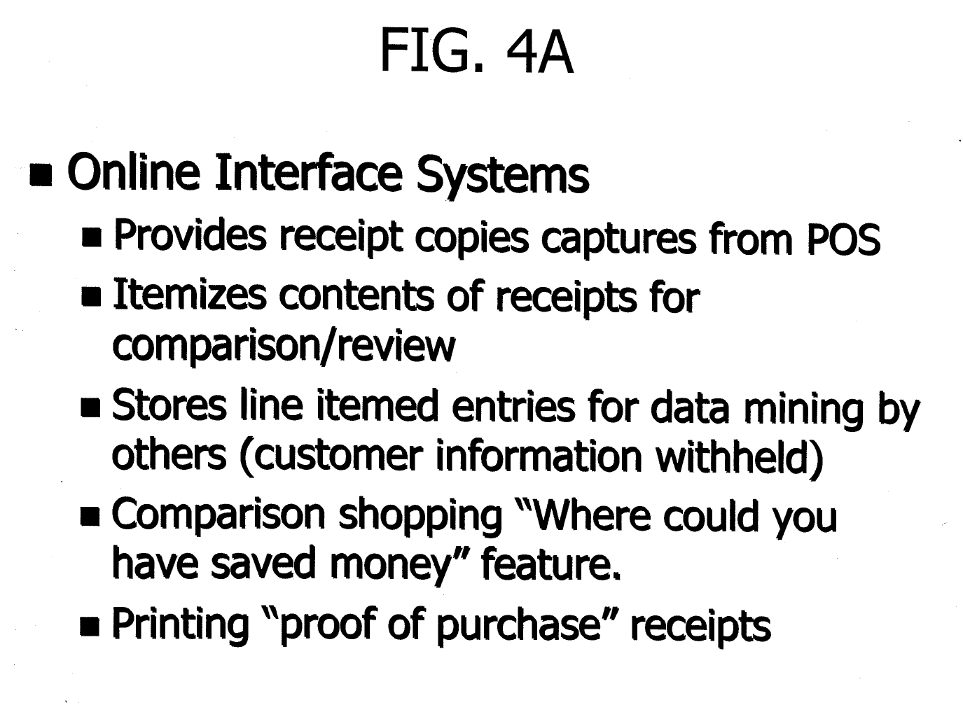

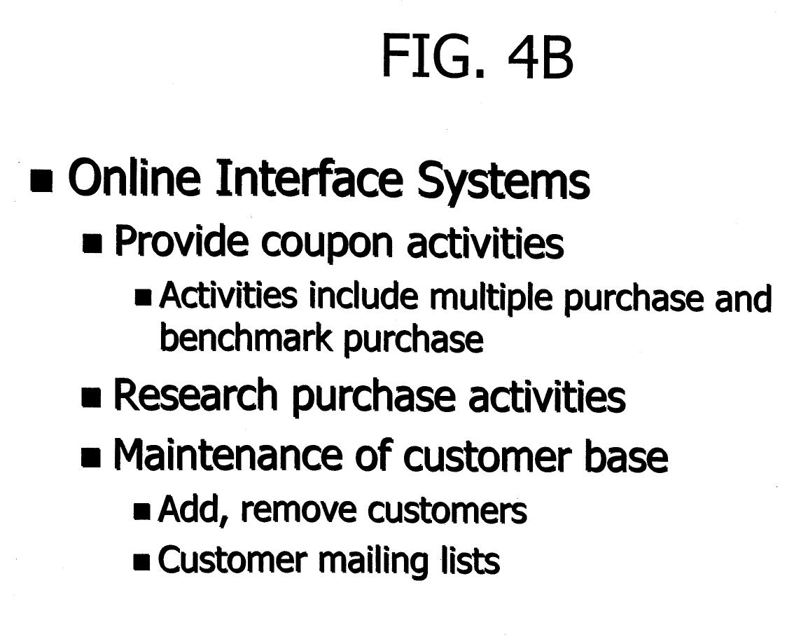

As shown in FIGS. 4A and 4B, the Data Center can provide the following value-added capabilities to Customer/Users:
1. Provide receipt copy captures from POS devices (never losing a receipt)
2. Itemize contents of receipts for comparison/review
3. Store line item entries for data use by third parties (e.g., tax reporting purposes)
4. Compares purchase and/or pricing information for unused savings
5. Print “proof of purchase” receipts for third party rebates or records
6. Provide discount or savings coupons earned by purchases
7. Research customer purchase activities as personal record-keeping
8. Maintenance of customer databases, mailing lists

The system may further provide Customer/Users with personal account management functions, such as:
1. Delete or modify receipt entries for returns, refunds, etc.
2. Move receipt entry to tabbed folders, for example, linked to vendors. The movement of receipts to folders may be automated where possible
3. Summarize receipt activities for specific vendors or purchased products
4. Purchase comparison with archived data from other vendors (as recorded by other customers in the same shopping area)
5. Coupon management capability
6. Upgrade account to archive large quantities of receipts/coupons
7. Review itemized receipt information
8. Link vendor VIP barcode cards to customer barcode ID.

### RBOT Protocol Description

A preferred example of a protocol description used by the RBOT device in the receipt data collection system is described below. This description includes all protocol commands as well as methodology.

Common acronym definitions used herein include:

| | |
|---|---|
| RCorp | Receipt Corporation |
| RBOT | Data collection apparatus |
| TCP | Telecommunications Control Protocol |
| UDP | User Datagram Protocol |
| IP | Internet Protocol |
| OLTS | Online Transaction System |
| OLDW | Online Data Warehouse |
| POTS | Plain Old Telephone System |
| RF | Radio Frequency (Khz-Ghz) |
| PPP | Point to Point Protocol |
| CRC | Cyclic Redundancy Check |

The RBOT protocol suite is used to transport data from the RBOT apparatus to the OLTS operated by RCorp. The protocol suite is defined by custom protocols used for two way communications with the RBOT apparatus. Currently, several carrier protocols have been defined:

RBOT to OLTS via POTS Modem

RBOT to OLTS via Internet (TCP/IP)

RBOT to OLTS via RF (UDP/IP)

RBOT to OLTS raw/unprocessed

The composite commands of the RBOT protocol suite are outlined below. Note that by and large, the RBOT protocol command structure definition is similar from carrier protocol to carrier protocol. The RBOT protocol was designed for software reusability during an implementation attempt.

### RBOT Operational Protocol

The RBOT Operational Protocol uses communication industry specific terms. These terms include Request, Reply, Indication and Response. Where a Request is received by a system, a Reply is mandatory. During this process, a timer is used to give the receiver a specific window of opportunity to respond. The lack of a response requires a retry operation. Where an Indication has been received, a Response is welcomed, but not required. No operation from an Indication can cause time out or failure events to occur.

These same principles are applied to the RBOT protocol. The following sections will out line the specific structures, commands, and System Description Language (Z. 120) of the system communication process.

1.0 RBOT Command Header

All carrier protocols, independent of their behavior, encapsulate the RBOT Command Header. The command header contains the necessary data to transport information from the RCorp Server to the RBOT apparatus.

| Field | Bits | Type | Description |
|---|---|---|---|
| TAG_ID | 64 | Uint64 | Tag Identification |
| TAG_LEN | 8 | Uint8 | Tag length |
| TAG_TYPE | 8 | Uint8 | Tag Type (i.e. 1-d, 2-d, 3-d) |
| RD_SEQUENCE | 16 | Uint16 | Receipt sequence number |
| PKT_NUM | 8 | Uint8 | Current Packet Number (UDP |
| | | | context) |
| PKT_TOT | 8 | Uint8 | Total packets (UDP context) |
| PKT_SIZ | 32 | Uint32 | Total packet size (UDP context) |
| DATA_CRC | 16 | Uint16 | Cyclic Redundancy Check (UDP |
| | | | context) |
| DATA_LEN | 16 | Uint16 | Length of contained data (59790 |
| | | | bits max) |
| DATA_CMD | 8 | Uint8 | Command Function |
| DATA_OP1 | 16 | Uint16 | Reserved |
| DATA_OP2 | 16 | Uint16 | Reserved |
| CHUNK | 0-60K | Uchar8 | Contained data |

A number of defined fields, such as PKT_NUM, PKT_TOT, etc., were specifically included for carrier protocols that do not contain a data control/link layer such as UDP. By including these fields for all protocols, this specification can be modified to handle newer protocols as they are identified.

1.1 RBOT Action Header

The RBOT Action Header is a condensed version of the Command Header. The Action Header contents vary from command to command, but an overall pre-defined structure is standard as defined below.

| Field | Bits | Type | Description |
|---|---|---|---|
| ACTION_ID | 0 | Uint16 | The specific action to be |
| | | | performed. |
| PKT_SEQUENCE | 16 | Uint16 | Sequential counter of |
| | | | packet number. |
| RETRY_COUNTER | 32 | Uint8 | Retry attempt |
| CMD_CRC | 40 | Uint16 | CRC of this packet |
| CHUNK | 58..512 | Uchar8 | Contained data specific |
| | | | to action. |

1.2 RBOT Commands

The RBOT header DATA_CMD field directs the specific action to occur with the contained data from either the server's perspective or the RBOT's perspective as defined below.

1.3 RBOT To Server

| Command | Value | Chunk | Description |
|---|---|---|---|
| DATA_REPLY | 1 | RBOT Command | Data contents |
| | | Header | |
| INFO_REPLY | 2 | RBOT Action | Resets data for re- |
| | | Header | transmission |
| ERR_IND | 3 | RBOT Action | Error code contains |
| | | Header | specific error to be |
| | | | transmitted to |
| | | | server. |
| RETRY_REQ | 4 | RBOT Action | Last packet |
| | | Header | unacceptable |
| CMD_INFO_REPLY | 5 | RBOT Information | Machine information |
| | | Header | of RBOT. |
| CMD_FW_DONE_RESP | 6 | RBOT Action | Flash blocks |
| | | Header | updated to flash |
| | | | successfully. |
| CMD_FLASH_ABORT | 7 | RBOT Action | Abort current flash |
| | | Header | effort. |
| CMD_INFO_UPDATE_REPLY | 8 | RBOT Action | Update specific |
| | | Header | contained status |
| | | | information of the |
| | | | RBOT. |
| CMD_FW_RETRANS_IND | 9 | RBOT Action Header | Retransmit missing |
| | | | Flash Load blocks. |

1.3.1 Command DATA_REPLY

In response to receiving information from the Server, RBOT shall indicate receipt of data with the DATA_REPLY code. Relevant contained data of the Action Header shall be the retry counter, Sequence Number, and Command Code.

1.3.2 Command INFO_REPLY

This command is in response to an INFO_REQ. The server may query this field for information during a flash load process, Server records update, or error action processing.

1.3.3 Command ERR_IND

An ERR_IND may occur at any point during protocol transaction with the Server. When an error, known or unknown, is detected, the RBOT may transmit this information to the Server for error action handling.

1.3.4 Command RETRY_REQ

Upon receiving an unacceptable packet, the RBOT may request for retransmission. The known sequence and command ID are included as a part of the RBOT Action Header. Should this information be unknown, the Sequence and Command fields of the action header should be set to 0 (zero).

1.3.5 Command CMD_INFO_REPLY

This is a response to a CMD_INFO_REQ from the Server. The RBOT shall respond with an RBOT Info Header structure.

1.3.6 Command CMD_FW_DONE_RESP

This field is in response to a Server side CMD_FW_DONE_IND. The CMD_FW_DONE_RESP command indicates that a completed Flash download operation was successful. The RBOT device performs a hard reset 500 ms after sending this command. See Flash Loading for further information.

1.3.7 Command CMD_FLASH_ABORT

The RBOT sends this command should an error condition occur. This instructs the Server that flash operations have been completely aborted by RBOT; the Server may then request further information from the CMD_INFO_REQ command. The Server must restart the flash operation from the beginning.

1.3.8 Command CMD_INFO_UPDATE_REPLY

In response to a CMD_INFO_UPDATE REQ, the RBOT replies using the CMD_INFO_UPDATE_REPLY command. This command uses an RBOT Action Header to indicate the success of the update. The Server may also query the updated settings using the CMD_INFO_REQ command. See Contained Information for further information.

1.3.9 Command CMD_FW_RETRANS_BLK

This command's CHUNK data is divided into a 32-bit array. Since the available data in the CHUNK for a stored 32-bit array is 113 elements, the most a retransmit can request is 113 block. This command can be sent multiple times during a Flash Load protocol change to request as many blocks as necessary without limit.

1.4 Server To RBOT

| Command | Value | Chunk | Description |
|---|---|---|---|
| DATA_REQ | 21 | RBOT Command | Identifies Server to RBOT |
| | | Header | and requests |
| | | | transmission of stored |
| | | | data. |
| ERR_RESP | 23 | RBOT Action Header | Response to RBOT error. |
| | | | Action code contains |
| | | | action to be performed |
| | | | for the transmitted |
| | | | error_code. |
| RETRY_REPLY | 24 | RBOT Information | Retransmission of |
| | | Header | specific RBOT |
| | | | Information Header. |
| CMD_INFO_REQ | 25 | RBOT Action Header | Request machine |
| | | | information from RBOT. |
| CMD_FLASH_START | 26 | RBOT Action Header | Instruct RBOT to enter |
| | | | flash programming mode. |
| CMD_FLASH_BLK | 27 | RBOT Information | A single block of flash |
| | | Header | information. |
| CMD_FLASH_ABORT | 28 | RBOT Action Header | Abort current flash effort. |
| CMD_FW_DONE_IND | 29 | RBOT Action Header | Write flash information. |
| CMD_UPDATE_INFO_REQ | 30 | RBOT Info Header | Request write action of |
| | | | Status information in |
| | | | RBOT machine. |

1.4.1 Command DATA_REQ

The Server shall send this command to request information from the RBOT machine. See the Receipt Transmission Block for further information.

1.4.2 Command ERR_RESP

This is a response field to the RBOT machine for a received ERR_IND. The response structure shall contain specific information on how the RBOT should handle the specific error. See Error Handling for further information.

1.4.3 Command RETRY_REPLY

This is a response to the RBOT's RETRY_REQ command. The Server will attempt to resend the information indicated by the RBOT Action Header structure received from the RETRY_REQ command. See Handling Retries for further information.

1.4.4 Command CMD_INFO_REQ

The CMD_INFO_REQ command requests the RBOT machine to respond with specific machine related information. The Server may use this command to request information during Flash load, upon connection, or to determine the state of the RBOT machine at any time.

1.4.5 Command CMD_FLASH_START

This command instructs the RBOT to enter the Flash Load state. See Flash Loading for further information.

1.4.6 Command CMD_FLASH_BLK

This command contains specific flash block information for RBOT processing. The Server shall transmit a flash executable to the RBOT when new a new flash load is available. See Flash Loading for further information.

1.4.7 Command CMD_FLASH_ABORT

The Server may receive this command from the RBOT, or it may transmit the command itself. In either case, both Server and RBOT give up on the current flash load process. To transmit the flash load, a new CMD_FLASH_START command process will be required. See Flash Loading for further information.

1.4.8 Command CMD_FW_DONE_IND

After sending the last block of flash information, the Server instructs the RBOT device to exit the flash loading process using this command. See Flash Loading for further information.

1.4.9 Command CMD_INFO_UPDATE

The Server may instruct the RBOT to perform specific action using this command. Actions such as write flash, reset counters and statistics, or modify internal settings are performed using this command. See Contained Information section for further information.

1.5 Receipt Transmission Block

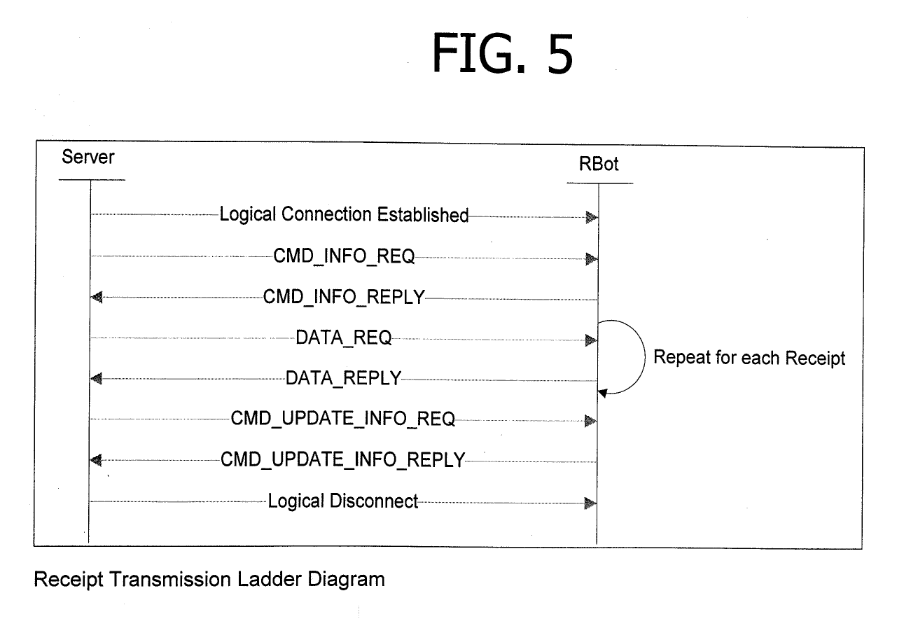

This section defines RBOT protocol handling during Receipt/Data transmission. The sequences outlined in the appended FIG. 5 demonstrate the typical transmission negotiated between Server and RBOT. There are extenuating circumstances not outlined in this section but are outlined in other sections. For example, error handling is outlined in the Error Handling section.

The initiation process requires a logical connection to be established. The connection is established using PPP, UDP, TCP or RF methods. At the protocol level of data transaction, the specifics of the logical connection are not relevant

Upon connection, the Server first requests the information structure from RBOT. One important communication consideration is determining the version and upgrading of flash operating within the RBOT. The version number will often dictate the exact protocol mechanisms to use during communication, thus allowing for backwards compatibility. The information structure also contains the total number of data elements (receipts) contained.

The Server begins receipt of a data element by transmitting a DATA_REQ command. The command structured contains the specific Receipt # to be downloaded. Receipts are number starting from 1 to the total number of receipts in the system. The RBOT shall not discard receipts until commanded to do so by the Server. This process is repeated for each receipt contained in the RBOT.

Upon completion, the Server updates TBD settings of the RBOT, which also instructs the RBOT to release all contained receipt data. The physical connection is released and the RBOT proceeds in the state instructed via the CMD_UPDATE_INFO_REQ command.

1.6 Error Handling

Error handling and recovery is an important function of the RBOT protocol. This section outlines those risks and contingencies that have been identified during specific actions of protocol exchange.

1.6.1 Receipt Transmission Block

This section outlines the common risk identified during receipt transmission block action.

1.6.1.1 Loss of Connection

At any point during receipt transmission it is possible to lose complete connection. Whether the loss of connection was generated from the server side or the RBOT side is irrelevant. The RBOT and Server must have their own identified recovery mechanism. This section outlines both mechanism identified.

RBOT Recovery: The RBOT shall recover by resetting the internal state to the last known state. Receipts transmitted and accepted by the Server are discarded from the RBOT memory. The RBOT shall record an abrupt loss of connection in its internal error log, along with time/date stamp. The RBOT will not make another attempt to connect to the server until its next, normal connection event is scheduled.

Server Recovery: The Server shall recover from an abrupt loss of connection by storing successfully receipt and acknowledge receipts. The Server logs the abrupt loss of connection the Server log along with time/date stamp of the event. This information shall be used to further gather statistical information about the connection quality of a specific RBOT.

1.6.1.2 Time Out of Exchange

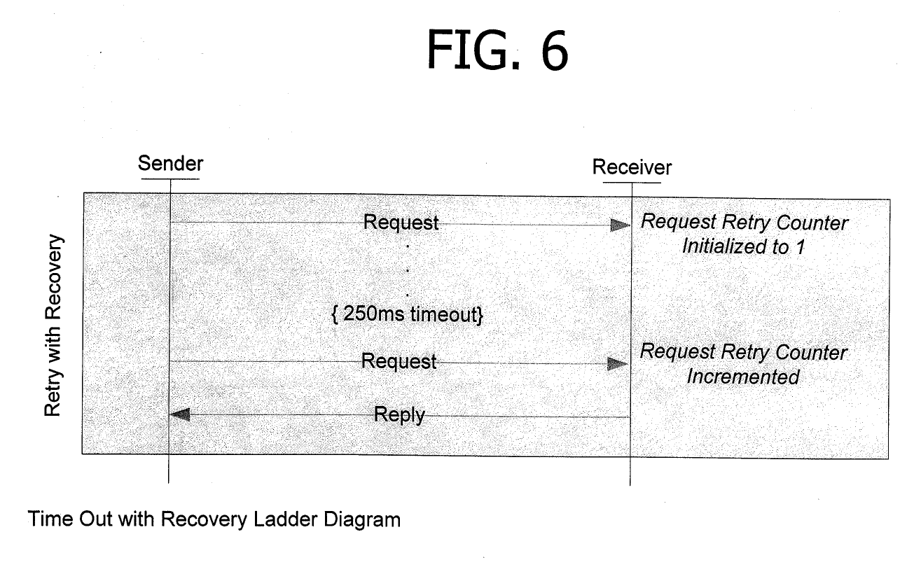

Upon sending any Request message, the sender shall initiate a protocol time out clock of no more than 500 ms. If the appropriate Reply is not received during this time period, the sender increments the retry counter and resends. When a message is received by the RBOT or the Server that has a retry counter greater than 1, the unit resends the last message. An example of the time out sequence with recovery ladder is shown in the diagram appended as FIG. 6.

It is important to note that a time out event could occur simultaneously to the transmitted Reply from the receiver. Should this be the case, the receiver of the message discards the message as a request has already been forwarded for a new copy if the message.

1.6.1.3 Retry Counter Exceeded

In the advent that a recovery is not possible, the communications linked is aborted after the 3^{rd} retry event fails. During the receipt block exchange, both the Server and RBOT disconnect and recover to their previous states as outlined in 1.6.1.1. The error logs on both the RBOT and Server shall designate the event to be caused from exceeding the retry counter limits. This information is important for Server side statistics gathering. In some events, it may be necessary to increment the retry counter for certain RBOTs because of connection quality.

1.6.1.4 CRC/Data Errors

It is rare that a CRC/Data error should occur under certain connection schemes. For example, TCP/IP provides a LLC CRC data assurance methodology, but this same methodology does not exist for UDP or Raw packets. For this reason, the RBOT Protocol includes an additional 16 bit CRC to every message.

When either the Server or RBOT receives a message with an incorrect CRC, the scenario shall behave as a time out event. That is, when a receiver detects a malformed CRC, the receiver shall discard the message and let the time out clock handle retransmission of the packet. This reduces system complexity, reutilizes existing schema, and allows the retry counter to also proxy for retransmission of malformed packets.

1.7 Flash Loading

This section outlines the Flash Loading behavior of the RBOT Protocol. The purpose of Flash Loading is to allow applications and data files to be remotely loaded to an RBOT device from the server. A typical scenario where this would occur is when a new RBOT application must be used by the RBOT. This process is also known as “code load”.

The RBOT memory shall contain two copies of the RBOT Flash code. The RBOT shall not store a Flash Load file unless it was completely received without any errors. Code Load rules and behaviors are outside the scope of this document. This section will, however, cover the protocol scope of the code load event.

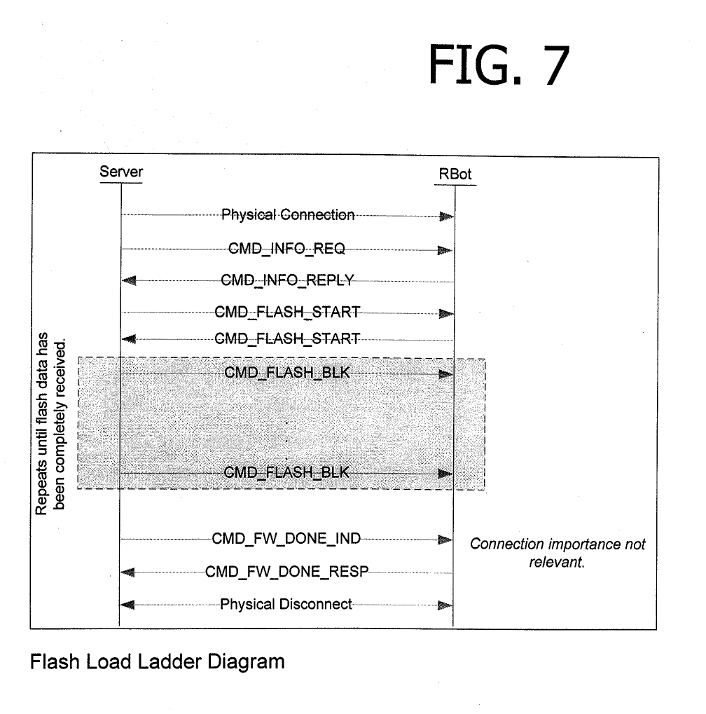

FIG. 7 shows a ladder diagram of a Flash Load exchange between the Data Center's server and the RBOT device.

The Flash Load begins with the Server initiating a CMD_FLASH_START message. If the RBOT is capable of receiving a flash load, it responds with the same CMD_FLASH_START message, with the Retry Counter set to 1 indicating a ready state. The contained CHUNK data for this message shall indicate the number of bytes required by the RBOT to store the Flash Load. Flash Load behavior is outside the scope of this document.

Once flash load begins, the Server transmits a sequential particle of code using CMD_FLASH_BLK. There shall be no less than a 120 ms delay between each message. As the file is received, the RBOT stores this data in an internal array. Blocks received with mismatched CRCs are discarded.

At the end of the transfer, the RBOT will have the opportunity to request specific blocks that were not transmitted or accepted. This shall be contained in the CMD_FW_RETRANS_BLK message. The adorned CHUNK to this message contains an array of unsigned long words (32 bits) of missing blocks. The Server must then retransmit those blocks as necessary. The RBOT continues this protocol exchange until all blocks have been received.

Upon completion, the RBOT responds to the Server's CMD_FW_DONE_IND with a CMD_FW_DONE_RESP. The RBOT shall not respond with the CMD_FW_DONE_RESP until all blocks have been received and are assembled into a readable, acceptable code load image.

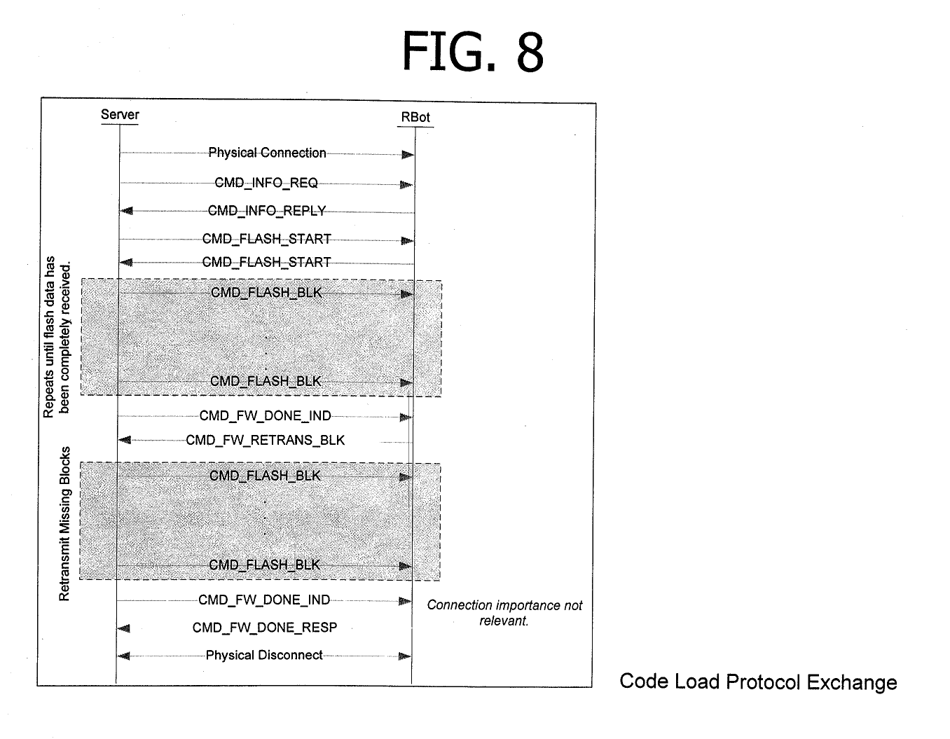

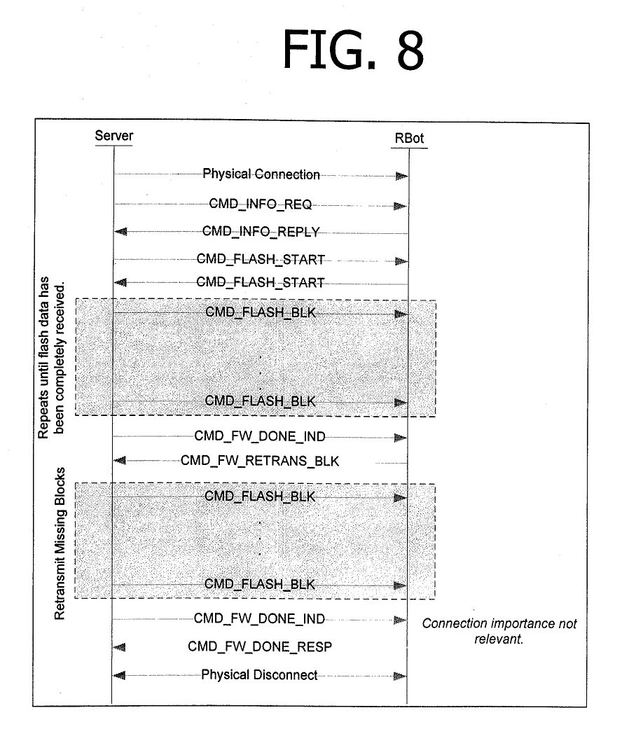

The reason for this specific type of code load protocol exchange is to support future Flash Load broadcast capabilities yet to be realized in the current system design. FIG. 8 shows a diagram of a code load protocol exchange between RBOT and Server.

1.8 Handling Retries

Retry events do not occur during any portion of the Flash Load protocol exchange. Should the connection be so poor as to cause portions of this exchange to fail, the RBOT should not be loading code at that time. When blocks become missing during the CMD_FLASH_BLK load, the RBOT can re-request those blocks upon completion. Failure of CMD_FLASH_START, CMD_FW_DONE_IND, CMD_FW_DONE_RESP and even CMD_FW_RETRANS_BLK indicate a poor connection and an unacceptable code load risk.

1.9 Contained Information

All contained RBOT Protocol structures have CRCs associated with them. These CRCs are independent of the transport link control, as not all link controls contain CRCs (e.g. UDP). Any block containing a failed CRC is discarded. The current protocol exchange state must treat this discarded block as either missing, in the case of Flash Loading, or timed out. Timed out Requests and Replies, during the Flash Load state, shall cause an immediate failure of Flash Loading. Retries are unacceptable during this important operation.

2 Carrier Protocol

The RBOT Protocol shall keep its design constraints limited to structures and behaviors that will continue to allow the protocol to be carried as a primary or underlying mechanism to other protocols. For example RBOT may be an underlying protocol to TCP, UDP, or PPP.

3 Data Assurance

Existing and future protocol structures and datasets shall define a 16-bit CRC token for data assurance. The accepted algorithm for CRC is thus:

xⁿ+ . . . +x²+x¹+x⁰

Data correct is not accomplished in the protocol at this time. When calculated CRC values do not matched the value from the data stream, the associated packet is said to be corrupted.

For structures that contain CRCs, the CRC calculated on that structure shall be done with the CRC field set to 0. The receiver will be required to pull the stream CRC and store in a temporary area. The stream CRC is then set to 0 and a CRC can then be calculated.

In summary, the receipt data collection system of this invention provides a robotic RBOT device to autonomously collect receipt data from a POS device tagged with the corresponding customer ID number and transmit the data to a Data Center for data warehousing and processing and making the results accessible online to vendors and customers. The RBOT device can thus be deployed with a wide range of different vendors and chain stores using different types of POS systems to upload receipt data to a common Data Center. The system enables aggregation of customer receipt data across different vendors and store chains and different POS domains. The customer's aggregated purchase information can be analyzed across a broad range of products and shopping venues for more useful data mining results to customers. The system can thus provide customers with a wide range of personal purchase data management functions. Aggregated product sales data can be analyzed across different vendors and store chains locally, regionally, and nationally and for purchaser preferences enabling targeted product advertising and promotions. Customer loyalty, discount and/or reward programs can thus be expanded beyond single-store or single-chain purchases.

It is understood that many modifications and variations may be devised given the above description of the principles of the invention. It is intended that all such modifications and variations be considered as within the spirit and scope of this invention, as defined in the following claims.

1. A system for data collection from a point-of-sale (POS) device comprising:
(a) a receipt data collection robotic (RBOT) device connected to a data output port of the POS device for collecting receipt data from the POS device and transmitting the data via a connection link to a data center, wherein said RBOT device operates autonomously and without communicating to the POS device; and
(b) a data center receiving transmissions of receipt data from a plurality of the above-described RBOT devices connected to a plurality of respective POS devices for storing and processing the receipt data received from the plurality of POS devices for desired data analysis functions thereon.

2. A system according to claim 1, wherein the RBOT device is connected to an auxiliary data port of the POS device separately from the data port the POS device uses to send receipt data to a receipt printer for printing.

3. A system according to claim 1, wherein the RBOT device is connected as an in-line module between the data port the POS device uses to send receipt data and a receipt printer for printing the receipt data.

4. A system according to claim 1, wherein said RBOT device is connected to a device for reading in a customer ID number of a customer engaged in a purchasing transaction at the POS device, and said RBOT device tags the read-in customer ID number to the receipt data generated for that customer in the purchasing transaction at the POS device.

5. A system according to claim 4, wherein said device for reading in the customer ID number is a barcode scanner built in to the RBOT device for reading in a customer's barcode ID number.

6. A system according to claim 4, wherein said device for reading in the customer ID number is an external barcode scanner coupled to the RBOT device for reading in a customer's barcode ID number.

7. A system according to claim 4, wherein said device for reading in the customer ID number is a magstripe reader connected to the RBOT device for reading a customer's magstripe ID card.

8. A system according to claim 4, wherein said RBOT device is configured in dual mode, wherein in a first mode it tags the read-in customer ID number to receipt data contemporaneously being collected from the POS device, and in a second mode it stores the read-in customer ID number if receipt data is not contemporaneously being collected from the POS device and starts a timed period during which it tags the read-in customer ID number to receipt data that is collected during the timed period.

9. A system according to claim 4, wherein said RBOT device collects the receipt data for a customer's purchasing transaction as a batch file tagged with the customer's ID number and transmits the tagged batch file to the data center for later parsing of data fields from the receipt data.

10. A system according to claim 1, wherein said RBOT device is connected by an Internet connection to the data center.

11. A system according to claim 1, wherein said RBOT device is connected by a phone line connection to the data center that is shared with an existing phone line connection to the POS device for other POS functions.

12. A system according to claim 9, wherein said data center identifies a store name or ID number from a store ID header in the batch file for loading and applying a corresponding receipt data formatting methodology associated with that store for parsing data fields in the receipt data batch file.

13. A system according to claim 1, wherein said data center is connected to an online website for allowing online access to vendors and/or customers to results of data analysis functions performed on the receipt data.

14. A system according to claim 1, wherein said data center performs data analysis functions for one or more vendor purposes in the group consisting of: inventory management; product sales analysis; customer incentive programs; product purchasing statistics; targeted advertisement; tracking grouped or targeted customer purchases; tracking customer multiple or volume purchases; tracking customer benchmark spending; maintenance of customer tracking database; tracking purchasing trends for products and/or manufacturers locally, regionally or nationally; and tracking price sensitivities and market demand.

15. A system according to claim 1, wherein said data center performs data analysis functions for one or more customer purposes in the group consisting of: providing receipt copy captures; itemizing contents of receipts for comparison/review; storing line item entries for data use by third parties; comparing purchase and/or pricing information for unused savings; printing “proof of purchase” receipts for third party rebates or records; providing discount or savings coupons earned by purchases; researching customer purchase activities; maintenance of customer databases; modifying receipt entries for returns, refunds, etc.; moving receipt entry to tabbed folders summarizing receipt activities for specific vendors or purchased products; comparing purchase data from other vendors; coupon management; upgrading account information; reviewing itemized receipt information; and linking vendor VIP cards to customer ID number.

16. A receipt data collection robotic (RBOT) device for collecting receipt data from a point-of-sale (POS) device comprising:
(a) a first interface for connection to a data output port of the POS device for collecting receipt data generated from the POS device for sending to a receipt printer for the POS device;
(b) a second interface for connection to a connection link to a remote data center for transmitting the collected receipt data to the data center,
wherein said RBOT device operates autonomously and without communicating to the POS device.

17. A receipt data collection robotic (RBOT) device according to claim 16, wherein the RBOT device is connected to an auxiliary data port of the POS device separately from the data port the POS device uses to send receipt data to the receipt printer for printing.

18. A receipt data collection robotic (RBOT) device according to claim 16, wherein the RBOT device is connected as an in-line module between the data port the POS device uses to send receipt data and the receipt printer for printing the receipt data.

19. A receipt data collection robotic (RBOT) device according to claim 16, wherein said RBOT device has a third interface for connecting to a device for reading in a customer ID number of a customer engaged in a purchasing transaction at the POS device, and said RBOT device tags the read-in customer ID number to the receipt data generated for that customer in the purchasing transaction at the POS device.

20. A receipt data collection robotic (RBOT) device according to claim 19, wherein said RBOT device is configured in dual mode, wherein in a first mode it tags the read-in customer ID number to receipt data contemporaneously being collected from the POS device, and in a second mode it stores the read-in customer ID number if receipt data is not contemporaneously being collected from the POS device and starts a timed period during which it tags the read-in customer ID number to receipt data that is collected during the timed period.
